(19) United States
(12) Patent Application Publication
(10) Pub. No.: US 2001/0048425 A1
(43) Pub. Date: Dec. 6, 2001

(54) Device or component for alphanumeric and direction input

(76) Inventor: Gary R. Partridge, Currumbin (AU)

Correspondence Address: BROWDY AND NEIMARK, P.L.L.C., 624 NINTH STREET, NW, SUITE 300, WASHINGTON, DC, 20001-5303, US

(21) Appl. No.: 09/843,700

(22) Filed: Apr. 30, 2001

(30) Foreign Application Priority Data
Apr. 28, 2000 (AU) PQ 7196
Apr. 28, 2000 (AU) PQ 7197
Apr. 28, 2000 (AU) PQ 7198

(51) Int. Cl. G09G 5/08

(52) U.S. Cl. 345/161

(57) ABSTRACT

A device or component for alphanumeric and direction input has a twelve-directional pad or twelve-zone directional joystick where the twelve directions (or zones) are allocated respective numerical values or letter groups, with further directional movement being allocated to respective characters within the group.

### BACKGROUND OF THE INVENTION

1. Field of the Invention

THIS INVENTION relates to a device or component for alphanumeric and direction input.

The invention is particularly suitable for, but not limited to, a device or component for alphanumeric and direction input that can register twelve (12) unique directions. The invention is particularly suitable for, but not limited to, such a device or component for equipment such as mobile phones, computer keyboards, personal organisers, pagers, television remote controls, hand-held computer games, and like equipment.

The invention also relates to methods of, and apparatus for, registering and recording alphanumeric characters and navigating menu systems.

2. Prior Art

A. The following devices exist for the input of Alphanumeric Data.

1) Keyboards (alpha and numeric) and keypads (numeric).

2) Mice/trackballs (using point and click on a display).

3) Tablets (including graphics).

4) Light pens.

5) Styli (eg., with PDA's).

6) Touch screens.

B. The following devices exist for controlling directional movement on a display (or screen).

1) Arrow keys (up, down, left, right) on a keyboard or keypad.

2) Mice or trackballs.

3) Tablets.

4) Light Pens.

5) Styli (eg., with PDA's).

6) Touch Screens.

7) Joysticks (designed primarily for games).

8) Directional Pads or Game Pads.

The term “Directional Pad” will be used to cover both the terms “Directional Pad” and “Game Pad”. The term “Pad” is used to represent a device or component that can register directional input in two or more directions. This differs from a “key” or “button” that can only register directional input in one direction, eg., an “arrow key” such as the “up key” on a computer keyboard.

Joysticks and Directional Pads are usually independent devices that connect to the “15 pin Games Port” or “USB port” of a computer.

However, they have more recently been integrated in Games consoles, eg., SuperNintendo, Nintendo 64, Nintendo Gameboy, Sony PlayStation, Sega Dreamcast (Trade Marks), etc.

These consoles include either only one (eg., the Directional Pad in the Nintendo Gameboy) or both (eg., Nintendo 64 with the joystick and the game pad) devices.

The area of focus however does not include devices with:

1) Many keys (eg., keyboards and keypads.

2) Mice or other devices that rely on motion across a fixed surface.

3) Trackballs or other devices that use a “rotating” ball.

4) A tablet (with or without a stylus).

5) Light pens, stylus or other devices.

6) Touch screens.

The term “device” will be used to cover both the terms “Device” and/or “Component”.

The area of focus centres is on two existing devices:

The Directional Pad

A device that can control position, movement and direction by controlling directional movement in either 4 or 8 directions. This device currently exists in two configurations:

a) A four (4) directional device that can register (respond to) 4 distinct input vales (ie., directions).

b) An eight (8) directional device that can register (respond to) 8 distinct input values (ie., directions).

The control and manipulation of the Directional Pad is designed to be controlled primarily by the thumb.

As the Directional Pad transmits either 4 or 8 distinct input values, it is usually classed as a “digital” device.

The Joystick

The Joystick currently exists in a number of variations. The primary function is to control position, movement and direction through a full 360° (360 degrees) of movement. The stick is manipulated either by:

a) the fingers and/or thumb;

b) the hand;

c) the thumb.

The Joystick registers a large range of input values. Although these values are distinct, they are usually determined by registering a location (an X and Y co-ordinate) that is the closest to the actual location of the Joystick as it is moving. Because the actual location can be anywhere (within the range of movement), it is usually classed as an “analogue” device.

Recently, the Directional Pad has appeared as a component in units other than those used to play games. For example:

1. TV Remote Controls.

2. Mobile Phones.

3. PDA's (Personal Digital Assistants).

4. Pagers.

These units have also seen the introduction of a two (2) directional device that can register (respond to) two distinct input values (ie., directions).

The Directional Pad used in these devices has primarily been for the purpose of navigating through “on-screen menus”, before selecting the required option. In the case of TV Remote Controls (where the display device is large), it is also used to move between and select channels, select programming functions, control picture quality and sound volume.

Problems and Limitations

The Joystick

The benefit of the joystick is that it offers movement in any direction through a full 360° (360 degrees). This benefit, however, also makes it difficult to “exactly” repeat any given movement, due to its ability to usually register between 200 and 400 distinct directions of movement.

The Directional Pad

By the nature of the three existing designs (2 way, 4 way and 8 way) these pads can only register either 2, 4 or 8 distinct data values.

### SUMMARY OF THE PRESENT INVENTION

Objectives

It is an object of the present invention to design a “directional device” that can be used for the entry of numeric and alpha (characters and symbols) date, and to register either 2, 4, 8 or 12 directions. (“Numeric” meaning the numbers 1, 2, 3, 4, 5, 6, 7, 8, 9, 0; “Alpha” meaning characters, text and symbols of any kind—in any language.)

Preferably, the device is:

to be easy to use.

take up a small surface area, so it can be used as part of other devices, where one of the design goals for these other devices includes being small in size.

to be able to use and build on existing production methods to keep the costs relatively low.

primarily to be used by the thumb.

One or more preferred objects of the present invention are to provide methods (techniques) of, and apparatus for:

a) registering and recording alphanumeric characters (as input data);

b) navigating and moving around this recorded data;

c) navigating and selecting items from a menu of items; and/or

d) using a joystick/joystick-type device or component.

It is a further preferred object that the entered data may or may not be displayed on an input device or screen, which may be below the directional pad or joystick.

Other preferred objects will become apparent from the following description.

### BROAD STATEMENT OF THE INVENTION

A) The Directional Pad

In one aspect, the present invention resides in a Directional Pad which can register twelve (12) distinct data values—and with (optional) additional functionality, can register and/or record multiple sets of twelve data values. Preferably, each of these distinct values is associated with a unique direction on the Directional Pad, ie., the Directional Pad is a twelve (12) Directional Pad.

The term “12D-Pad” will be used to represent this twelve (12) Directional Pad.

These values can preferably be converted to:

a) directions;

b) numbers; and/or

c) characters or symbols.

The 12D Pad can have numerous shapes. For example:

a) Circular;

b) Elliptical;

c) A twelve (12) sided Polygon;

d) A 12-pointed Star; or

e) Any other shape with which twelve directions can be registered.

B) The Joystick

In a second aspect, the present invention resides in a Joystick which can register twelve (12) distinct data values—and with additional (optional) functionality, can register and/or record multiple sets of twelve data values. Each of these distinct values is preferably associated with a unique “zone of direction” on the Joystick.

The term “Zone” will be used to represent a “slice” of the Joystick's outer perimeter of movement. In the following discussion, the outer perimeter of movement will be deemed to be a circle, and each Zone to cover a 30° arc (ie., 1/12 of a circle). if the top of the circle is set to 0°, then the first Zone (Zone 1) will be set to start at 15°, and the second Zone (Zone 2) to start at 45°, and so on—through to Zone 12, starting at 345°. That is, the Joystick becomes a twelve Zone directional Joystick.

The term “12Z-Joystick” will be used to represent this twelve (12) zone directional Joystick.

These values can be converted to:

a) directions;

b) numbers; and

c) characters or symbols.

The 12Z-Joystick can have numerous shapes. For example:

a) Circular;

b) Elliptical;

c) A twelve (12) sided Polygon;

d) A 12-pointed Star; or

e) Any other shape with which twelve directions can be registered.

In a third aspect, the present invention resides in a method where a joystick, or joystick-type device, is operable to register and record alphanumeric characters.

In a fourth aspect, the present invention resides in an apparatus for the method.

In a fifth aspect, the present invention resides in a method where a joystick or joystick-like device, is used to navigate menu systems.

In a sixth aspect, the present invention resides in an apparatus for the method.

In a seventh aspect, the present invention resides in a combination of the methods of the first and third aspects.

In an eighth aspect, the present invention resides in a combination of the apparatus of the second and fourth aspects.

### BRIEF DESCRIPTION OF THE DRAWINGS

To enable the invention to be fully understood, preferred embodiments will now be described with reference to the accompanying drawings, in which:

FIGS. 1 and 2 are alternative schematic design layouts for twelve (12) direction pads;

FIGS. 3 and 4 are alternative schematic design layouts for twelve (12) zone directional joysticks;

FIG. 5 illustrates an example of a direction-number assignment for the twelve (12) directional pad;

FIG. 6 illustrates an example of a direction-number assignment for the twelve (12) zone directional joystick;

FIGS. 7 and 8 illustrate alternative examples of direction-character allocation assignments for the twelve (12) directional pads, and for the twelve (12) zone directional joysticks;

FIGS. 9 and 10 illustrate alternative schemes for directional navigation through menus and/or text on the twelve (12) directional pad, and on the twelve (12) zone directional pad;

FIG. 11 illustrates how the twelve (12) zone joystick can be enhanced to improve the accuracy of the directional input;

FIG. 12 illustrates an embodiment of the control switch layout for the 12-D pad;

FIGS. 13 to 27 illustrate alternative embodiments of methodology for the assignment and input of alphanumeric characters for the 12-Z joystick;

FIGS. 28 and 29 illustrate embodiments of selecting menu options available;

FIGS. 30 to 33 illustrate alternative applications of the device to watches and other devices; and

FIGS. 34 to 37 illustrate devices where the display is below the input device (ie., directional pad or joystick).

### PREFERRED EMBODIMENTS

To enable the invention to be fully understood, a number of preferred embodiments, discussing a range of uses of the invention, will now be described with reference to the accompanying drawings.

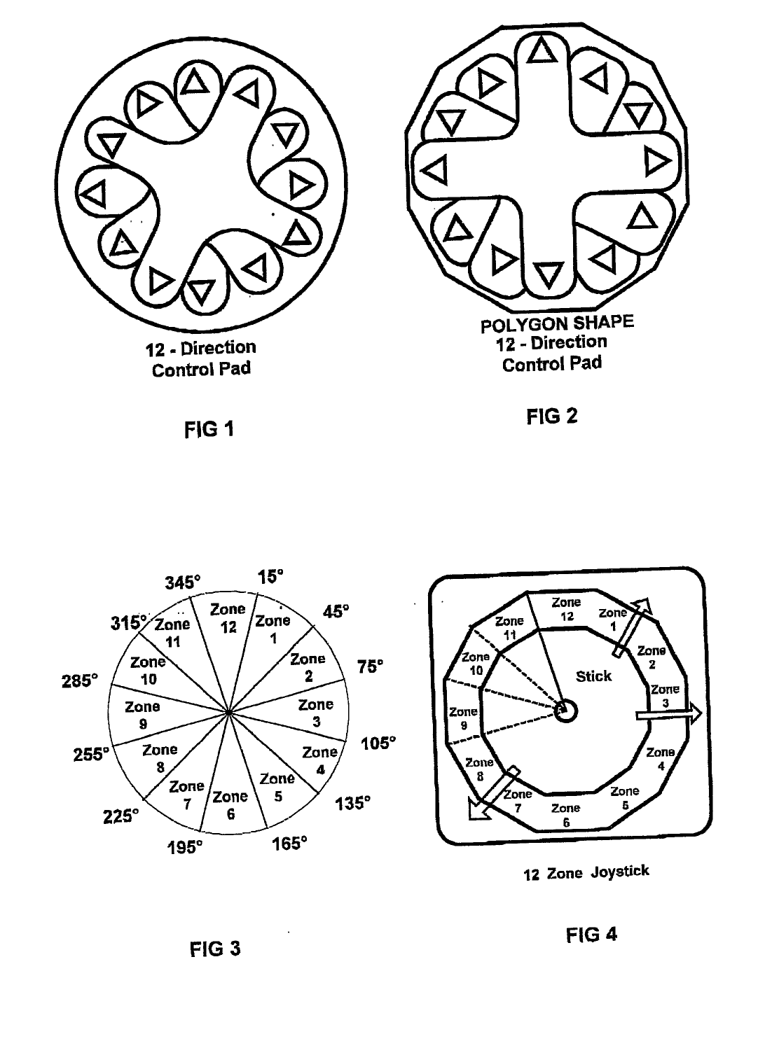

FIGS. 1 and 2 illustrate alternative schematic design layouts for the twelve (12) direction pads, including circular and 12-sided polygon.

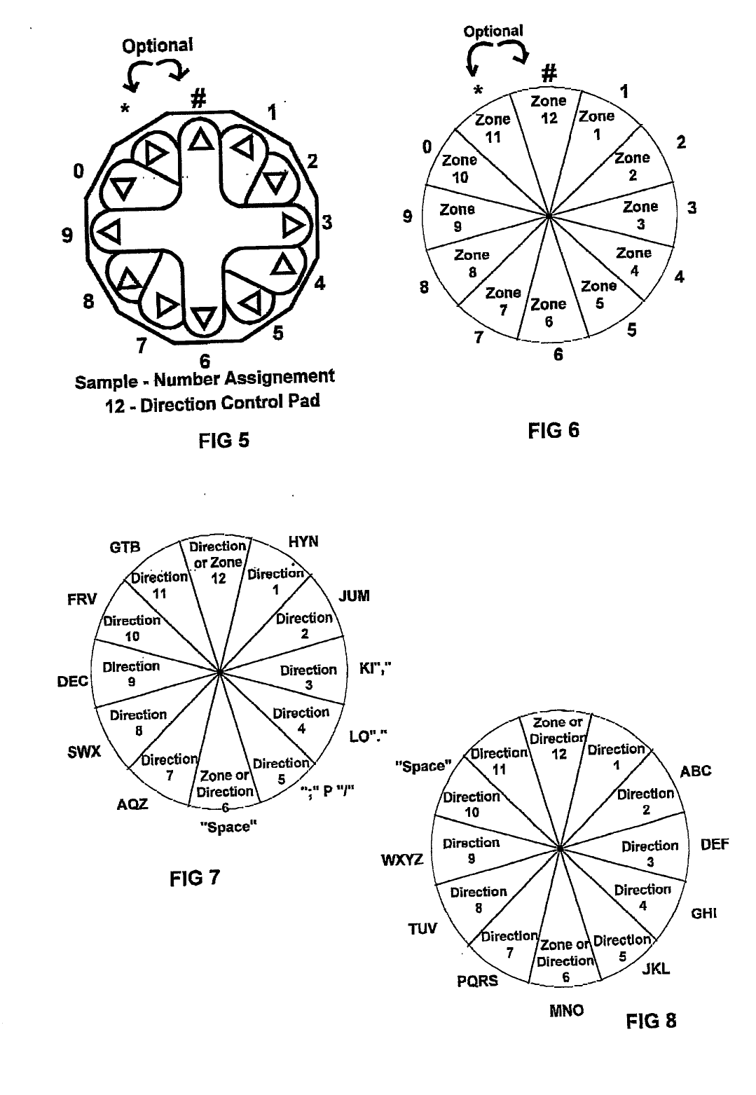

Similarly, FIGS. 3 and 4 illustrate alternative schematic design layouts for the twelve (12) direction joysticks, including the shapes described above.

A) Using the 12D-Pad and the 12Z-Joystick to input numbers.

1. The 12D-Pad

Allocate to ten of the twelve directions, the numerals 1, 2, 3, 4, 5, 6, 7, 8, 9, 0. Symbols, characters or functions can be allocated to the other two directions. For example, allocating “*” and “#” to the two remaining directions would allow the 12D-Pad to be used successfully on mobile phones.

Assigning the numerals 1, 2, 3, 4, 5, 6, 7, 8, 9 to the nine directions on a standard watch/clock face (ie., 1 to the 1 o'clock direction, 2 to the 2 o'clock direction, etc.) and the numeral “0” to the 10 o'clock direction, provides an assignment that is practical and easy to remember.

After the assignment above, it is a now simple matter to enter any number using the 12D-Pad. For example, to enter the number “730”, press down on the 12D-Pad at the “7 o'clock position, followed by the “3 o'clock” position, followed by the “10 o'clock” position.

2. The 12Z-Joystick

Allocate to ten of the twelve directions (ie. zones) the numerals 1, 2, 3, 4, 5, 6, 7, 8, 9, 0.

Symbols, characters or functions can be allocated to the other two directions. For example, allocating “*” and “#” to the two remaining directions would allow the 12Z-Joystick to be used successfully on mobile phones.

The Zone layout defined above, is the same as assigning the numerals 1, 2, 3, 4, 5, 6, 7, 8, 9 to the nine directions on a standard watch/clock face (ie., 1 to the 1 o'clock direction, 2 to the 2 o'clock direction, etc.) and the numeral 0 to the 10 o'clock direction. This provides a layout that is practical and easy to remember.

After the assignment above, it is a now simple matter to enter any number using the 12Z-Joystick. For example, to enter the number “730”, move the Joystick out into Zone 7, then move the joystick out into Zone 3, then move the joystick out into Zone 10.

See “D1. Enhancements (2.)” in the section “Variations and Enhancements” for a method of registering this movement.

See “D2. Variations (1.)” in the section “Variations and Enhancements” for an alternate number assignment to that above.

B) Using the 12D-Pad and the 12Z-Joystick to input characters (A-Z).

1. The 12D Pad

Allocate to some or all of the twelve directions, groups of characters in such a way, that all of the characters of the alphabet have been assigned.

Many options exist for grouping characters together. Two recommended “groupings” are:

a) the grouping used on “QWERTY” keyboards, as follows

AQZ

SWX

DEC

FRV

GTB

HYN

JUM

KI “,”

LO “.”

“;” P “/”

Space

Slight variations to the above can also be used. However, these variations have no effect on the methods outlined herein.

b) The grouping used on telephones and mobile phones, as follows:

ABC

DEF

GHI

KJL

MNO

PQRS

TUV

WXYZ

Space

Slight variations to the above exist in different countries. However, these variations have no effect on the method outlined herein.

Next, set up a “Primary Allocation Schema” (many other combinations would also be valid).

Two recommended allocation schemas are as follows:

Character Allocation Schema No. 1

In this schema, each direction is allocated a group of characters, That is, either one, two or three characters (or symbols)—generally three characters, with a maximum of three characters.

| | | |
|---|---|---|
| AQZ | to | direction 7 (7 o'clock) |
| SWX | to | direction 8 (8 o'clock) |
| DEC | to | direction 9 (9 o'clock) |
| FRV | to | direction 10 (10 o'clock) |
| GTB | to | direction 11 (11 o'clock) |
| HYN | to | direction 1 (1 o'clock) |
| JUM | to | direction 2 (2 o'clock) |
| KI “,” | to | direction 3 (3 o'clock) |
| LO “.” | to | direction 4 (4 o'clock) |
| “;” P “/” | to | direction 5 (5 o'clock) |
| Space | to | direction 6 (6 o'clock) |

Direction 12 is left free, and could be allocated to any other “characters” and/or functions (eg., “$”, “#”, “+”, “−”, “*”, “/”).

Character Allocation Schema No. 2

| | | |
|---|---|---|
| ABC | to | direction 2 (2 o'clock) |
| DEF | to | direction 3 (3 o'clock) |
| GHI | to | direction 4 (4 o'clock) |
| KJL | to | direction 5 (5 o'clock) |
| MNO | to | direction 6 (6 o'clock) |
| PQRS | to | direction 7 (7 o'clock) |
| TUV | to | direction 8 (8 o'clock) |
| WXYZ | to | direction 9 (9 o'clock) |
| Space | to | direction 0 (10 o'clock) |

(see FIG. 17).

Directions 1, 11 and 12 are left free, and could be allocated to any other “characters” or “functions” (eg., “$”, “#”, “+”, “−”, “*”, “/”).

NB: Any “character grouping” could have been allocated to any unique direction. However, one of the two allocations above provide practical and recognisable layouts.

To enter and register characters, use a technique similar to that used on mobile phones (that use twelve or more keys). That is, press down on a particular direction one or more times, as required, to cycle through the available characters in a particular direction.

For example, in “Character Allocation Schema No. 2” above:

to register the letter “A”, press “Direction 2” once;

to register the letter “B”, press “Direction 2” twice;

to register the letter “C”, press “Direction 2” three times.

See “D1. Enhancements (3.)” in the section “Variations and Enhancements” for enhancements to the above technique.

2. The 12Z-Joystick

Many options exist for grouping characters together. Two recommended “groupings” are:

(a) the grouping used on “QWERTY” keyboards, as follows:

AQZ

SWX

DEC

FRV

GTB

HYN

JUM

KI “,”

LO “.”

“;” P “/”

Space

(b) The grouping used on telephones and mobile phones, as follows:

ABC

DEF

GHI

JKL

MNO

PQRS

TUV

WXYZ

Space

Slight variations to the above exist in different countries. However, these variations have no effect on the method outlined herein.

Next, set up a “Primary Allocation Schema” (many other combinations would also be valid.

Two recommended Primary Allocation Schemas are as follows:

Character Allocation Schema No. 1

In this schema, each zone is allocated a group of characters. That is, either one, two or three characters (or symbols)—generally, three characters, with a maximum of three characters.

| | | |
|---|---|---|
| AQZ | to | zone 7 |
| SWZ | to | zone 8 |
| DEC | to | zone 9 |
| FRV | to | zone 10 |
| GTB | to | zone 11 |
| HYN | to | zone 1 |
| JUM | to | zone 2 |
| KI “,” | to | zone 3 |
| LO “.” | to | zone 4 |
| “;” P “/” | to | zone 5 |
| Space | to | zone 6 |

(see FIG. 17).

Zone 12 is left free, and could be allocated to any other “characters” or “functions” (eg., “$”, “#”, “+”, “−”, “*”, “/”).

Character Allocation Schema No. 2

| | | |
|---|---|---|
| ABC | to | zone 2 |
| DEF | to | zone 3 |
| GHI | to | zone 4 |
| JKL | to | zone 5 |
| MNO | to | zone 6 |
| PQRS | to | zone 7 |
| TUV | to | zone 8 |
| WXYZ | to | zone 9 |
| Space | to | zone 10 |

(see FIG. 8).

Zones 1, 11 and 12 are left free, and could be allocated to any other “characters” or “functions” (eg., “$”, “#”, “+”, “−”, “*”, “/”).

NB: Any other “character grouping” could have been allocated to any unique zone. However, one of the two allocations above provide practical and recognisable layouts.

To enter and register characters, use a technique similar to that used on mobile phones (that use twelve or more keys). That is, move the 12Z-Joystick out into the required zone one or more times, as required to cycle through the available characters in a particular zone.

For example, in “Character Allocation Schema No. 2”, above:

to register the letter “A”, move the 12Z-Joystick out into “Zone 2” once;

to register the letter “B”, move the 12Z-Joystick out into “Zone 2” twice;

to register the letter “C”, move the 12Z-Joystick out into “Zone 2” three times.

C) Using the 12D-Pad and the 12Z-Joystick to input 2, 4, 8 to 12 directions.

Registering directional movement allows:

a) navigating through text (numbers, characters and symbols);

b) navigating through on-screen menus.

1. The 12D-Pad can be used to register:

a) two “Major Directions” (at 180° to each other) by allocating 1, 3 or 5 of the standard 12 directions to these “Major Directions”.

For example, “UP” could be registered by recognising either:

Direction 12; or

Directions 11, 12, 1; or

Directions 10, 11, 12, 1, 2.

b) Four “Major Directions” (at 90° to each other) by allocating 1 or 3 of the standard 12 directions to these “Major Directions”.

For example, “UP” could be registered by recognising either:

Direction 12; or

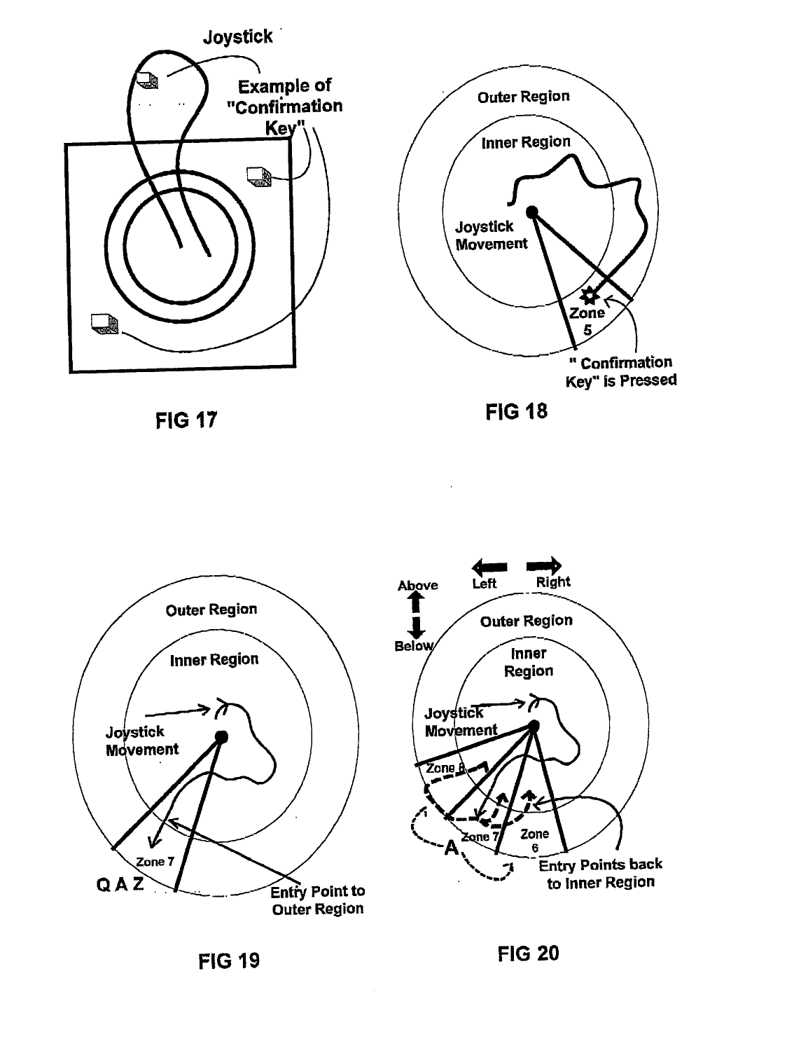

Directions 11, 12, 1. (see FIGS. 9 and 10).

c) Eight “Major Directions” (at 45° to each other) by allocating 1 and/or 2 of the standard 12 directions to these “Major Directions”.

For example, “UP” (or “NORTH”) could be registered by recognising:

Direction 12; or

The direction between “UP” and “RIGHT” (or “NORTH-EAST”) could be registered by recognising Directions 1 and 2.

d) Twelve “Major Directions” (at 30° to each other) by allocating 1 of the standard 12 directions to each of these “Major Directions”. For example, “UP” could be registered by recognising Direction 12.

The 12Z-Joystick can be used to register:

a) Two “Major Directions” (at 180° to each other) by allocating 1, 3 or 5 of the standard 12 zones to these “Major Directions”.

For example, “UP” could be registered by recognising either:

Zone 12; or

Zones 11, 12, 1; or

Zones 10, 11, 12, 1, 2.

b) Four “Major Directions” (at 90° to each other) by allocating 1 or 3 of the standard 12 zones to these “Major Directions”).

For example, “UP” could be registered by recognising either:

Zone 12; or

Zones 11, 12, 1. (see FlGS. 9 and 10).

c) Eight “Major Directions” (at 45° to each other) by allocating 1 and/or 2 of the standard 12 zones to these “Major Directions”.

For example, “UP” (or “NORTH”) could be registered by recognising:

Zone 12; or

The direction between “UP” and “RIGHT” (or “NORTH-EAST”) could be registered by recognising Zone 1 and 2.

d) Twelve “Major Directions” (at 30° to each other) by allocating 1 of the standard zones to these “Major Directions”.

For example, “UP” could be registered by recognising Zone 12.

D) Variations and Enhancements.

D1. Enhancements

(1.) Enhancements to the 12Z-Joystick design.

Adding “directional barriers” or “gates” on the 12Z-Joystick outer perimeter to help guide the 12Z-Joystick movement to a particular zone. The barriers would be placed between each of the zones.

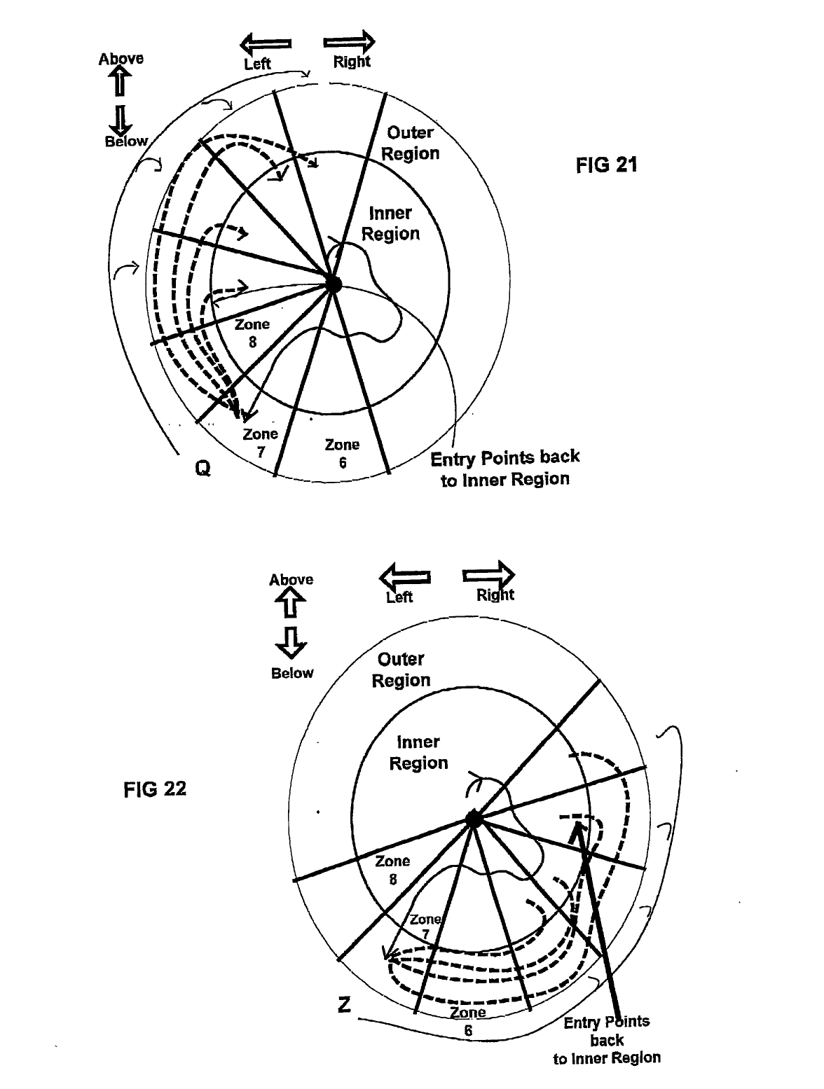

As the joystick is moved outward from the centre to the outer perimeter, in the direction intended, it is guided into that specific zone (see FIG. 11 for example).

(2). Enhancements to the 12D-Pad.

The (existing) eight directional pad usually uses four (4) electrical contacts to register the eight (8) directions. This is achieved by associating four (4) of the directions to a single switch “on” condition—and the other four (4) directions are associated with two (2) adjacent switches being “ON”.

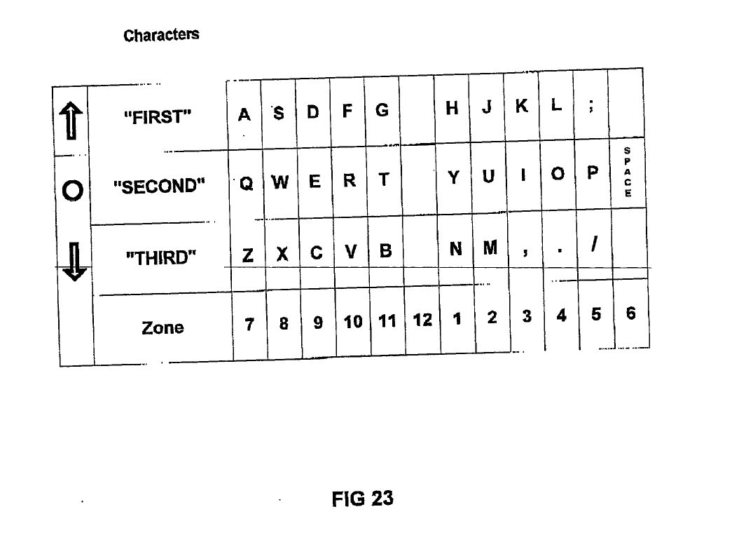

One of the proposed embodiments (enhancements) would have six (6) electrical contacts—which would allow the registration of twelve (12 ) directions, ie., six (6)×single contacts, six (6) by “dual” contacts—see FIG. 12.

(3.) Methods for registering and recording movement on a 12Z-Joystick.

For example: Registering and Recording “Numbers”.

Option I

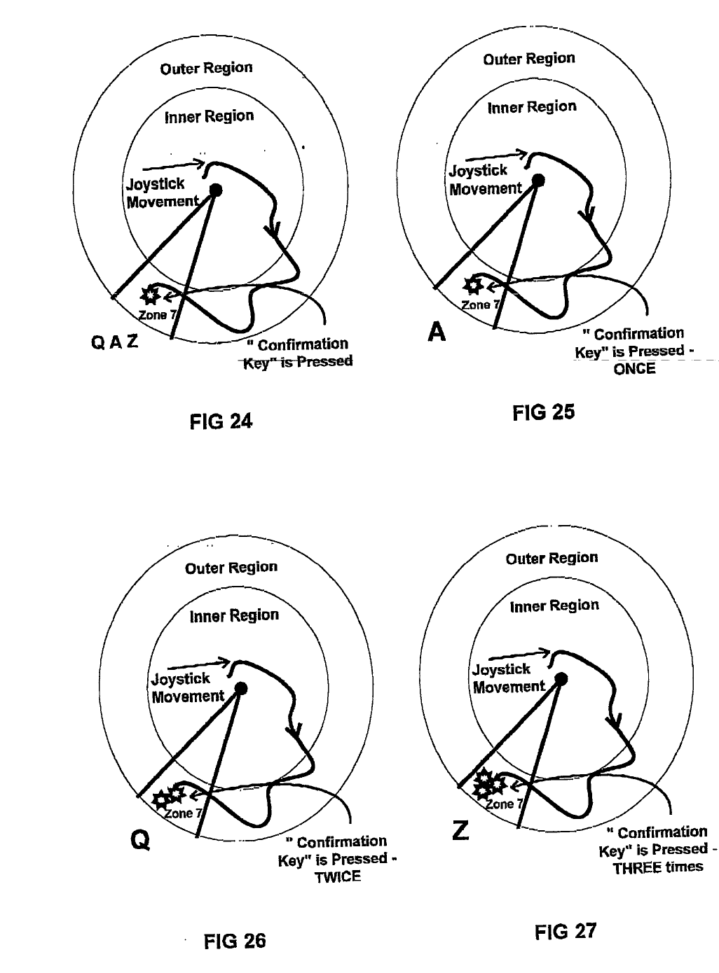

(i) Within the movement range of the joystick, designate two distinct regions, an “inner region” and an “outer region” (see FIGS. 13 and 14).

(ii) Move the joystick away (out) from the centre position.

(iii) When the joystick leaves the inner region and enters the outer region, record which zone this occurs in.

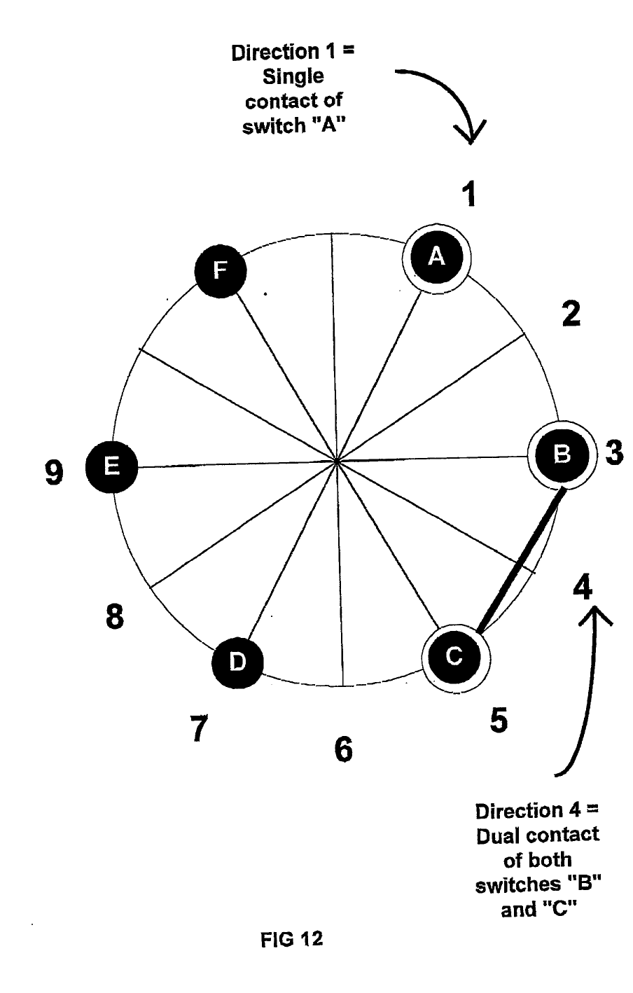

(iv) Allocate the equivalent number for this zone—as per FIG. 6. For example, if in Zone 5, allocate the number 5 (see FIG. 15).

(v) Continue to monitor the joystick position until the joystick moves back into the inner region (see FIG. 16). (NB: The joystick does not need to return to the inner region in the same zone from where it originated, as it is the zone from which it left the inner region that determines the “number” allocated. The process could, however, require that leaving from and returning to the inner region occurs in the same zone if required. This could be used as a method of “error checking”. However, it would probably increase the quantity of attempts to get the correct number desired.)

(vi) At this point, confirm and record the allocated number and monitor the joystick for the next time it leaves the inner region.

(vii) Repeat the process to record, and save numbers, until they do not need to be recorded.

(viii) Entry into zones 11 and 12 can be registered in the same way, and if other characters (eg., “*” and “#”) have been allocated to these zones, these values can be recorded. Alternatively, if “functions” have been allocated to these zones, these functions can be recorded (and performed when required).

Option II

(i) Within the movement range of the joystick, designate two distinct regions, an inner region and an outer region (see FIGS. 13 and 14).

(ii) Move the joystick away (out) from the centre position.

(iii) When the joystick leaves the inner region and enters the outer region, start monitoring for a “confirmation key” or “confirmation” button being pressed. This key or button may be on the joystick itself or somewhere else on the unit/device being used (see FIG. 17).

(iv) When the key/button is pressed, record which zone the joystick is currently in and allocate the equivalent number for this zone—as per FIG. 6 (see FIG. 18).

(v) Continue to monitor the joystick position and monitor for pressing of the confirmation key/button.

(vi) Whenever the joystick is in the outer region and the confirmation key/button is pressed, record the number associated with the zone the joystick is in.

NB: There is no requirement for the joystick to return to the inner region between number selection, although this may be more practical. This can be made a requirement if desired.

(vii) Repeat the process to record, and save numbers, until they do not need to be recorded.

(viii) Entry into zones 11 and 12 can be registered in the same way, and if other characters (eg., “*” and “#”) have been allocated to these zones, these values can be recorded. Alternatively, if “functions” have been allocated to these zones, these functions can be recorded (and performed when required).

NB: Option (I) may provide a simpler method over Option (II), as it does not require the pressing of a confirmation key/button.

Option (III)

In this option, assign each of the three characters in each group, one of the following three labels—“ABOVE”, “CENTRE”, “BELOW”, eg., in the group of “QAZ”, allocate:

Q is assigned “ABOVE”

A is assigned “CENTRE”

Z is assigned “BELOW”.

(i) Within the movement range of the joystick, designate two distinct regions, an “inner region” and an “outer region”;

(ii) Move the joystick away (out) from the centre position.

(iii) When the joystick leaves the inner region and enters the outer region, record which zone this occurs in.

(iv) Allocate the equivalent “group” of characters for this zone. For example, if this occurs in zone 7, allocate the group consisting of QAZ (see FIG. 19).

(v) Continue to monitor the joystick position until the joystick moves back to the inner region.

(vi) If the joystick moves back into the inner region in either (a) the same zone, or (b) the zone “immediately above” or to the immediate left, or (c) the zone “immediately below” or to the immediate right, then assign the “CENTRE” character of the corresponding allocated group as the “REQUIRED CHARACTER”, eg., in the QAZ group assign “A” as the “REQUIRED CHARACTER” (see FIG. 20).

Henceforth, an area of “three zones” grouped together will be known as “3Zone”.

If the joystick moves back into the inner region in either of the “next” four zones “immediately above” or to the immediate left of the 3Zone, then assign the “ABOVE” character of the corresponding allocated group as the “REQUIRED CHARACTER”, eg., in the QAZ group assign “Q” as the “REQUIRED CHARACTER” (see FIG. 21) (also refer FIG. 22).

(vii) At this point, confirm and record the “REQUIRED CHARACTER” and monitor the joystick for the next time it leaves the inner region.

(viii) Repeat the process to record, and save, “REQUIRED CHARACTER/S” until they do not need to be recorded.

(ix) Entry into zone 12 can be registered in the same way, and if other characters (eg., “*”, “#” or “$”) have been allocated to this zone, these values can be recorded as the “REQUIRED CHARACTER”. Alternatively, if “functions” have been allocated to this zone, these functions can be recorded (and performed when required).

NB: Options—the above procedures also work if in (vi) above, the option—“the joystick must ONLY return in ‘(a) the same zone’” is used. Also, if the “next four zones” is replaced with “next one, two or three zones”. However, these options require a much more exact movement of the joystick to obtain the same result

Option (IV)

In this option, assign each of the three characters in each group, one of the following three labels—“FIRST”, “SECOND”, “THIRD ”, eg., in the group of “QAZ” allocate—

“A” is assigned “FIRST”

“Q” is assigned “SECOND”

“Z” is assigned “THIRD”

(see FIG. 23 for a full assignment).

(i) Within the movement range of the joystick, designate two distinct regions, an “inner region” and an “outer region”.

(ii) Move the joystick away (out) from the centre position.

(iii) When the joystick leaves the inner region and enters the outer region, start monitoring for a “confirmation key” or “confirmation button” being pressed. This key or button may be on the joystick itself or somewhere else on the unit/device being used (see FIG. 18).

(iv) Allocate the equivalent “group” of characters for this zone. For example, if this occurs in zone 7, allocate the group comprising of QAZ (see FIG. 24).

(v) While the joystick is still positioned in the outer region continue to monitor to see if the confirmation key is pressed more than once.

(vi) If the confirmation key is pressed only once (before the joystick returns to the inner region) then assign the FIRST character of the corresponding allocated group as the “REQUIRED CHARACTER”, eg., in the QAXZ group assign “A” as the “REQUIRED CHARACTER” (see FIG. 25).

If the confirmation key is pressed twice (before the joystick returns to the inner region) then assign the SECOND character of the corresponding allocated group as “REQUIRED” character”, eg., in the QAZ group assign “Q” as the “REQUIRED CHARACTER” (see FIG. 26).

If the confirmation key is pressed three times (before the joystick returns to the inner region) then cycle through the FIRST, SECOND, THIRD characters as required (see FIG. 27).

(vii) Continue to monitor the joystick position until the joystick moves back into the inner region.

(viii) At this point, confirm and record the “REQUIRED CHARACTER” and monitor the joystick for the next time it leaves the inner region.

(ix) Repeat the process to record, and save “REQUIRED CHARACTER/S” until they do not need to be recorded.

(x) Entry into zone 12 can be registered in the same way, and if other characters (eg., “*” and “#” and “$”) have been allocated to this zone, these values can be recorded as the “REQUIRED CHARACTER”. Alternatively, if “functions” have been allocated to this zone, these functions can be recorded (and performed when required).

This method (pressing multiple times) is similar to that used when pressing keys on a mobile phone to alternate between characters.

NB: Option (III) may provide a simpler method over Option (IV) as it does not require the pressing of a confirmation key/button.

(f) Use a “backspace” or “delete” function to correct numbers being entered and recorded.

Option (V)

(iv) Allocate/assign one or more key/buttons on or next to the joystick for this function (ie., a backspace key).

(v) Monitor for an occurrence of the backspace key being used (either in the inner or outer regions).

(vi) If the backspace key is pressed, then backspace or delete the appropriate number/character (being displayed).

(3.) Using “Predictive Text”

Above in section “B) Using the 12D-Pad and the 12Z-Joystick to input characters (A-Z).

1. The 12D-Pad

The technique outlined below—

To enter and register characters, use a technique similar to that used on mobile phones (that use twelve or more keys). That is, press one or more keys, as required, to cycle through the available characters on a particular key.

For example, in “Character Allocation Schema No. 2” above:

to register the letter “A”, press “Direction 2” once;

to register the letter “B”, press “Direction 2” twice;

to register the letter “C”, press “Direction 2” three times.

2. The 12Z-Joystick

The technique outlined below—

To enter and register characters, use a technique similar to that used on mobile phones (that use twelve or more keys). That is, press one or more keys, as required, to cycle through the available characters on a particular key.

For example, in “Character Allocation Schema No. 2” above:

to register the letter “A”, move the 12Z-Joystick out into “Zone 2” once;

to register the letter “B”, move the 12Z-Joystick out into “Zone 2” twice;

to register the letter “C”, move the 12Z-Joystick out into “Zone 2” three times.

The above techniques could be enhanced by using a “predictive text” software component/engine such as T9® from Tegic Communications based in Seattle, USA. T9® uses an internal linguistic database to determine the most likely correct word—when a sequence of “character groups” is entered.

By using T9® the number of times—a) the directions on the 12D-Pad need to be pressed, and b) the zones on the 12Z-Joystick need to be entered—would be significantly reduced.

(4.) Navigating Menus.

Menu Design

As screens (displays) become larger, and display resolution improves, it will be possible to display more information (text and graphics) on a single screen.

By organising menu options at the perimeter on a geometric shape (eg., circular shape), it would be possible to select options—by moving a joystick in a particular direction or by selecting (pressing) a single direction on a “directional pad”.

For example:

a) On a menu offering up to four (4) options, the selection of a single option could be made by using the:

| | | |
|---|---|---|
| UP | or | 12 o'clock position |
| DOWN | or | 6 o'clock position |
| RIGHT | or | 3 o'clock position |
| LEFT | or | 5 o'clock position |

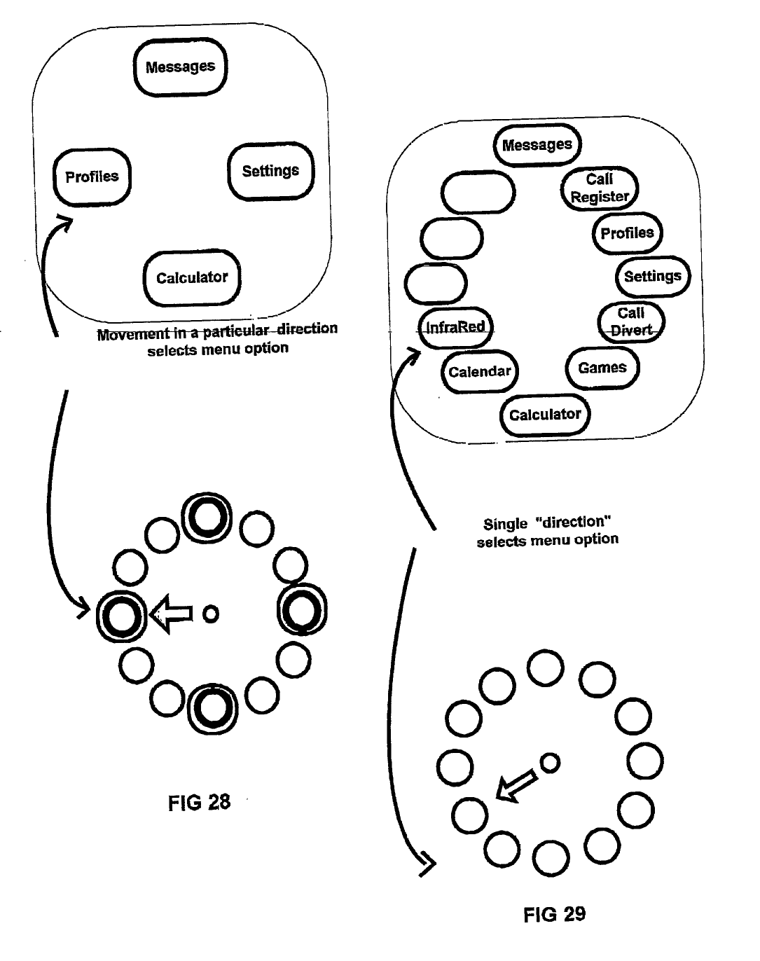

(see FIG. 28).

b) On a menu offering up to twelve (12) options, the selection of a single option could be made using all or some of the 12 positions (as per a standard clock/watch face) (see FIG. 29).

Each menu could lead to another menu (and so on) if required.

In a) above, two menu levels could provide up to 16 (4×4) options, and three menu levels could provide up to 64 (4×4×4) options.

In b) above, two menu levels could provide up to 144 (12×12) options, and three menu levels could provide up to 1,728 (12×12×12) options.

(D2.) Variations

(1.) Alternate number assignments.

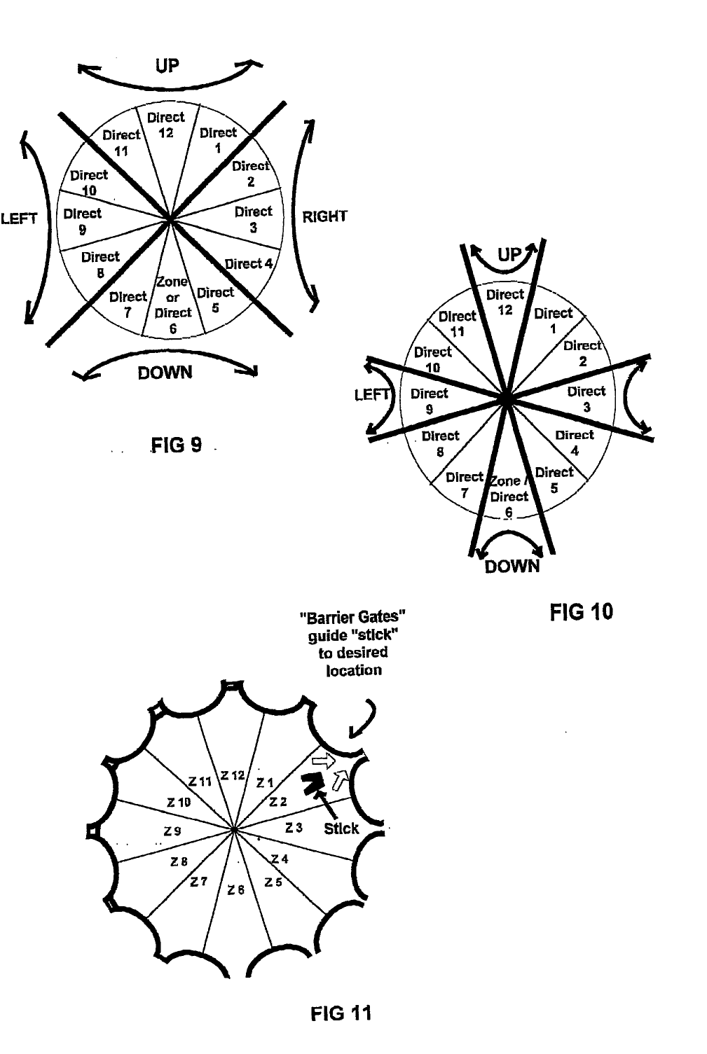

An alternate number assignment to that described previously (in FIGS. 5 and 6) is to allocate the numbers to match the QWERTY character assignment described previously.

That is:

| | Character | Direction |
|---|---|---|
| Number | Group | Zone |
| 1 | AQZ | 7 |
| 2 | SWX | 8 |
| 3 | DEC | 9 |
| 4 | FRV | 10 |
| 5 | GTB | 11 |
| 6 | HYN | 1 |
| 7 | JUM | 2 |
| 8 | KI “,” | 3 |
| 9 | LO “.” | 4 |
| 0 | P “;” “/” | 5 |

(see FIG. 23).

(2). Placing a 12D-Pad or a 12Z-Joystick on the face of a watch.

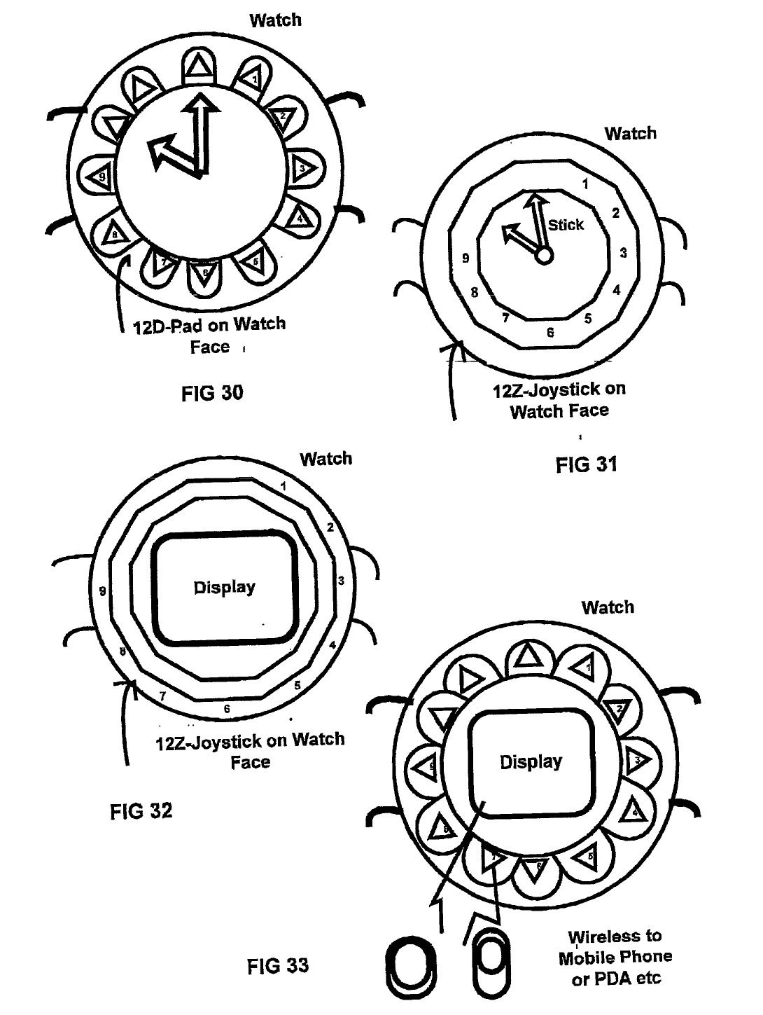

Using a miniature version of either of the above as the face of a watch. The watch display would be placed on/in the centre of either device to display either date/time, etc., or data stored in the watch (see FIGS. 30, 31 and 32).

Using the techniques previously described, it would now be possible to enter data (numbers and text) by pushing/moving the 12D-Pad or 12Z-Joystick on the watch.

As a variation, the watch face could also contain a display, that could show (display) the output from the mobile phone, PDA, or other device that transmits output data to it via wireless (eg., infrared or “bluetooth”).(see FIG. 33).

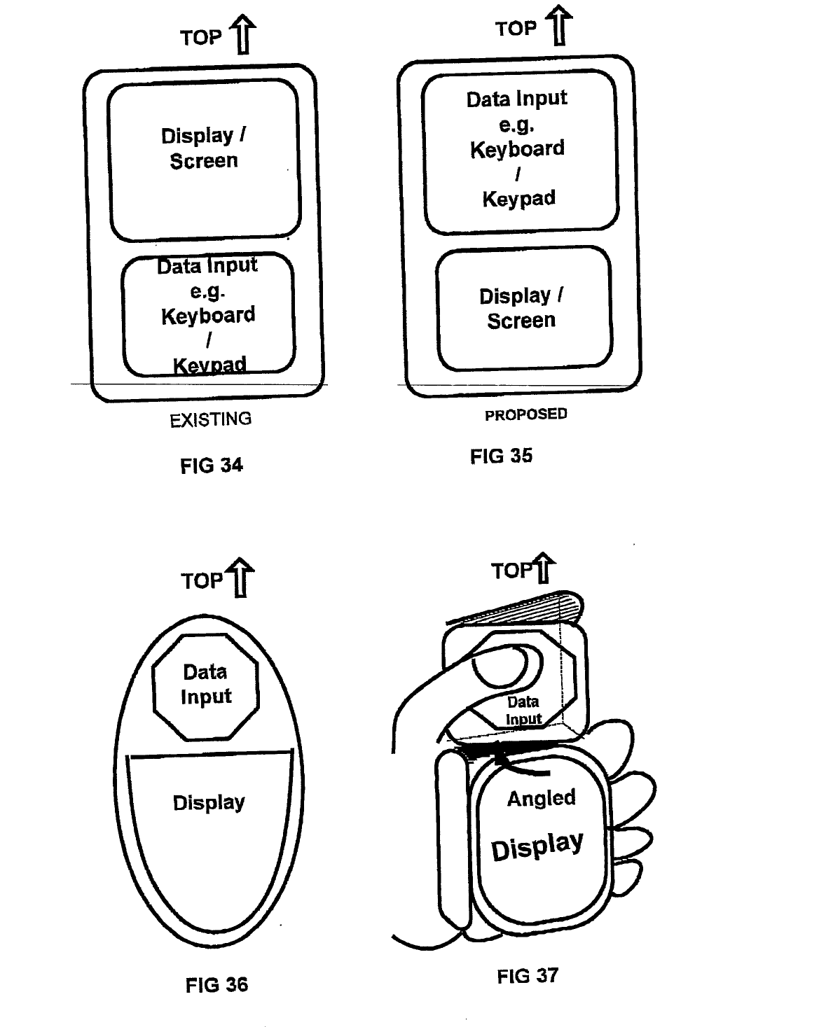

(3). To maximise the efficiency, the productivity, the comfort and/or ease of use of the devices hereinbefore described, that incorporate a screen/display to present information (alphanumeric and/or graphical)—where a user chooses to or needs to use these devices with only one hand—the display/screen may be placed at the “bottom” (not top) of these devices, ie., to place the data entry component (a keypad or any other data entry component or method) at the top of the device (see FIGS. 34 and 35).

For example, suitable applications include:

(i) for the disabled—where a user has only one hand.

(ii) for safety—where the other hand is required to control another device (eg., driving a vehicle).

(iii) for efficiency/productivity—where the user wishes to utilise the other hand for some other purpose.

FIG. 36 illustrates the general embodiment where a keypad, buttons and/or directional input component are provided above the display/screen component, the devices having a range of alternative shapes.

A variation to the above design, which meets the objectives (ie., to maximise the efficiency, productivity, the comfort and ease of use of mobile phones and other devices)—is to place the input component of the device (particularly mobile phones) at an “angle”, ie., not in the same plane as the display/screen component (see FIG. 37).

Placing the input component at an angle to the display/screen component allows the input component to be tilted toward the thumb to make it easier, more comfortable and more efficient to manipulate the input component. Two alternatives for the above are:

a) to use a design where the angle of the input component is permanently fixed (ie., either to the “left” or to the “right” of the display/screen. The consequence of this would be that one design (eg., angled to the left) would cater to people wishing to primarily hold the phone in the left hand, and another design (eg., angled to the right) would cater to people wishing to primarily hold the phone in the right hand.

b) to use a design where the “top” input component can be rotated left or right to provide increased ease of use, increased efficiency and comfort when held in either hand (see FIG. 63).

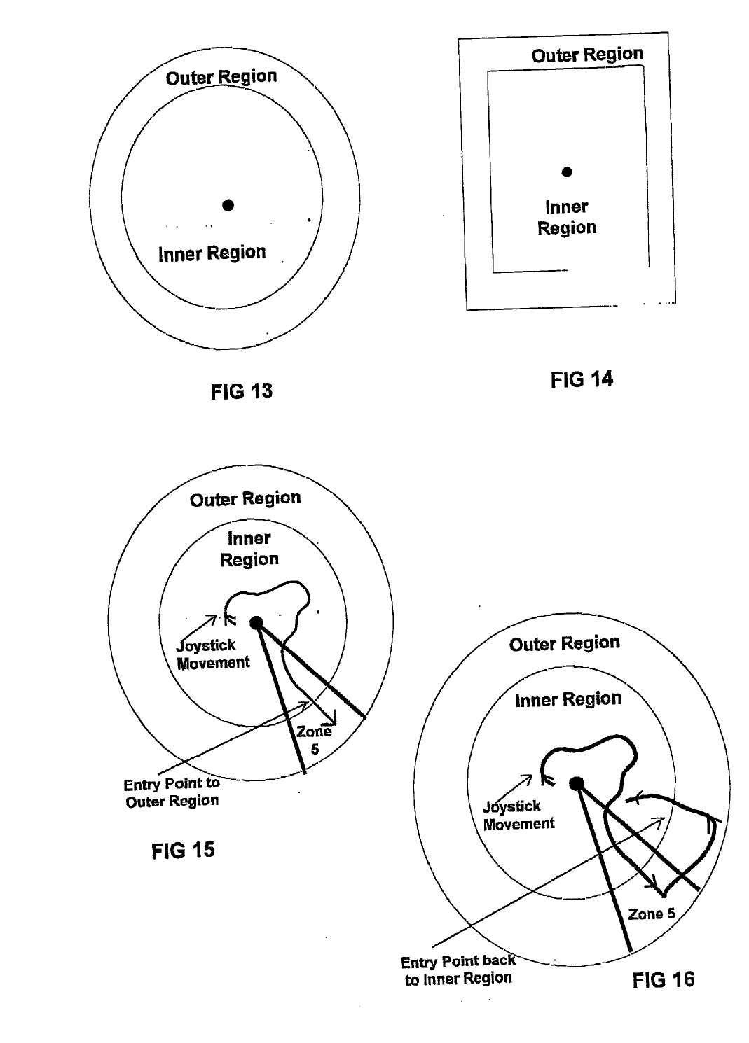

It will be readily apparent to the skilled addressee that various changes and modifications may be made to the embodiments illustrated in FIGS. 1 to 37, inclusive without departing from the present invention.

We claim:

1. A device or component for data input comprising a directional pad having twelve directions, wherein each direction is allocated a data value or set of data values.

2. A device or component for data input comprising a joystick having twelve zones of direction, wherein each zone is allocated a data value or set of data values.

3. A device or component as claimed in claim 1 or claim 2 wherein ten of the twelve directions or zones are allocated numerals and the other two directions or zones are allocated symbols, characters or functions.

4. A device or component as claimed in claim 1 or claim 2 wherein up to ten of the twelve directions or zones are allocated groupings of letters of the alphabet and at least two directions or zones are allocated symbols, characters or functions.

5. A device or component as claimed in claim 4 wherein:
to distinguish between the different letters, symbols, characters or functions in a direction or zone, the pad or joystick is moved or operated in that direction or zone one or more times dependent on the letter, symbol, character or function to be input by the device or component.

6. A device or component as claimed in claim 5 wherein:
for the joystick, the direction by which the joystick enters and/or leaves a zone, or enters and moves within a zone, distinguishes the particular letter, symbol, character or function in the zone, from the group therein, to be input by the device or component.

7. A device or component as claimed in claim 5 wherein:
for a joystick, a confirmation button or key is operable one or more times while the joystick is in a zone to distinguish letter, symbol, or character function in the zone, from the group therein, to be input by the device or component.

8. A device or component as claimed in claim 1 or claim 2 wherein a direction or zone, or group of characters or zones, can register a direction of movement when navigating through text and/or a menu.

9. A device or component as claimed in claim 1 or claim 2 wherein:
a display is provided below the pad or joystick.
